(19) United States
(12) Patent Application Publication
(10) Pub. No.: US 2019/0094885 A1
(43) Pub. Date: Mar. 28, 2019

(54) ALTITUDE CONTROLLABLE FLYING DEVICE, METHOD OF FLYING THE SAME, AND RECORDING MEDIUM

(71) Applicant: CASIO COMPUTER CO., LTD, Tokyo (JP)

(72) Inventors: Hideaki Matsuda, Tokyo (JP); Shunsuke Yamada, Tokyo (JP); Toshihiro Takahashi, Tokyo (JP); Takahiro Mizushina, Kawagoe-shi (JP)

(21) Appl. No.: 16/135,925

(22) Filed: Sep. 19, 2018

(30) Foreign Application Priority Data
Sep. 22, 2017 (JP) 2017-181893

(51) Int. Cl. G05D 1/04; G01C 5/00; G01W 1/00

(52) U.S. Cl. CPC G05D 1/046; G01W 2001/003; G01W 1/00; G01C 5/005

(57) ABSTRACT

A flying device includes a propulsion unit, a distance sensor, a controller, a determiner and a control modifier. The propulsion unit enables the flying device to fly in air. The distance sensor determines a distance from the flying device to a reference plane. The controller controls an altitude of the flying device based on a value output from the distance sensor. The determiner determines occurrence of an environmental change due to a shift of the reference plane. The control modifier modifies control of the controller in a case in which the determiner determines the occurrence of the environmental change.

### CROSS-REFERENCE TO RELATED APPLICATIONS

This application is based upon and claims the benefit of priority from the prior Japanese Patent Application No. 2017-181893, filed on Sep. 22, 2017, the entire contents of which are incorporated herein by reference.

### BACKGROUND OF THE INVENTION

### 1. Field of the Invention

The present invention relates to technology for controlling an altitude of a flying device flying in air.

### 2. Description of the Related Art

For example, JP2015-217785A discloses a small unmanned flying device referred to as “drone”. Techniques are also disclosed for controlling an altitude (a distance between the flying device and a reference plane) of the drone through determination of the altitude with an ultrasonic distance sensor.

### SUMMARY OF THE INVENTION

To achieve at least one of the abovementioned objects, according to a first aspect of the present invention, a flying device includes:

a propulsion unit enabling the flying device to fly in air;

a distance sensor determining a distance from the flying device to a reference plane;

a controller controlling an altitude of the flying device based on a value output from the distance sensor;

a determiner determining occurrence of an environmental change due to a shift of the reference plane; and

a control modifier modifying control of the controller in a case in which the determiner determines the occurrence of the environmental change.

According to a second aspect of the present invention, a method of flying a flying device in air comprising a distance sensor includes steps of:

controlling an altitude of the flying device based on a value output from the distance sensor;

determining occurrence of an environmental change due to a shift of a reference plane; and

modifying control of a controller in a case in which the occurrence of the environmental change is determined.

According to a third aspect of the present invention, a recording medium stores a program executed to instruct a computer of a flying device flying in air and comprising a distance sensor, to function as:

a controller which controls an altitude of the flying device based on a value output from the distance sensor;

a determiner which determines occurrence of an environmental change due to a shift of a reference plane; and

a control modifier which modifies control of the controller in a case in which the occurrence of the environmental change is determined by the determiner.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is an external view of a flying device with motor frames that are closed according to an embodiment of the present invention.

FIG. 1B is an external view of the flying device with the motor frames that are open.

FIG. 2 illustrates an example of system configuration of the flying device.

FIG. 3 is a flow chart illustrating an example of altitude control process.

FIG. 4 is a flow chart illustrating an example of calibration process.

FIG. 5 is a flow chart illustrating an example of altitude measuring process.

FIG. 6 is a flow chart of an example of control process for shift of the flying device to a target altitude.

FIG. 7 is a flow chart illustrating an example of process of updating the target altitude.

FIGS. 8A to 8C are schematic diagrams illustrating an altitude control of the flying device according to the embodiment of the present invention.

### DETAILED DESCRIPTION OF THE INVENTION

Hereinafter, one or more embodiments of the present invention will be described with reference to the drawings. However, scope of the invention is not limited to the disclosed embodiments.

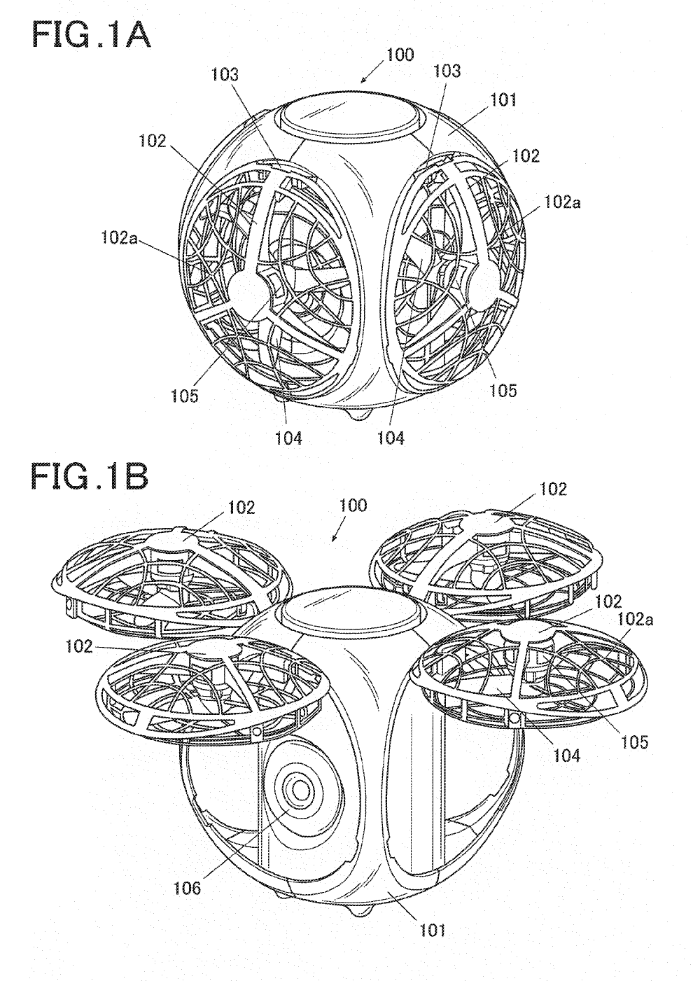

FIGS. 1A and 1B are external views of a flying device 100 according to an embodiment of the present invention. In detail, FIG. 1A is an external view of a spherical exterior of the flying device 100 with motor frames 102 that are closed. FIG. 1B is an external view of the flying device 100 with the motor frames 102 that are open.

As shown in FIGS. 1A and 1B, the flying device 100 includes a main frame 101 and four motor frames 102.

The motor frames 102 are attached to the main frame 101 with hinges 103. The motor frames 102 support respective motors 105. Rotor blades 104 are fixed to motor shafts of the respective motors 105. Finger guards 102a are provided on peripheral portions of the motor frames 102. Four motors 105, four rotor blades 104, and four motor drivers 404 (described below) constitute a propulsion unit.

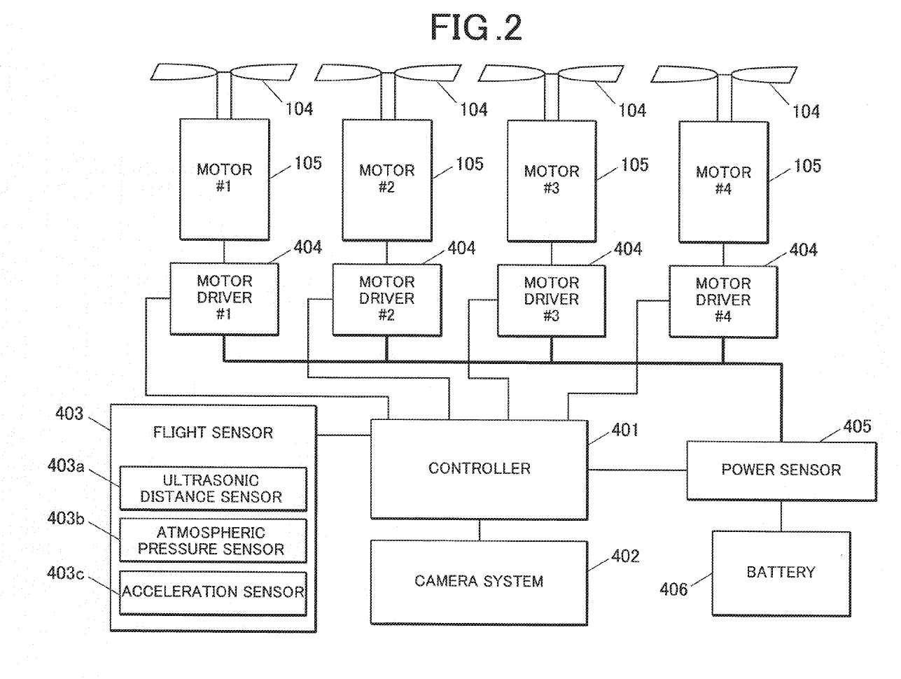

A camera (image capturing unit) 106 is fixed to a central portion of the main frame 101. The camera 106 can capture images in a direction of gravity of the flying device 100. The main frame 101 accommodates control units illustrated in FIG. 2.

The hinges 103 are rotatable within a range of 0 to 90 degrees such that the motor frames 102 can change between the “closed mode” suitable for launching the flying device 100 illustrated in FIG. 1A and the “open mode” suitable for flight of the flying device 100 illustrated in FIG. 1B.

FIG. 2 illustrates an example of system configuration of the flying device 100.

With reference to FIG. 2, a controller (determiner, controller, control modifier) 401 including, for example, a computer or a CPU (not shown) is connected to a camera system 402 including the camera 106 (see FIG. 1); a flight sensor 403 including an ultrasonic distance sensor 403a that measures a distance from the flying device 100 to a reference plane (a relative altitude of the flying device 100), an altimeter or an atmospheric pressure sensor 403b that measures an altitude above sea level or an absolute altitude of the flying device 100, and an acceleration sensor 403c; first to fourth motor drivers 404 driving first to fourth motors 105 (see FIG. 1), respectively; and a power sensor 405 that feeds power to the motor drivers 404 while monitoring voltage of a battery 406. Although not illustrated, the power of the battery 406 is also fed to control units 401 to 405. The controller 401 receives information on the altitude of the flying device 100 from the flight sensor 403 in real time. The controller 401 monitors the voltage of the battery 406 with the power sensor 405 and sends power instruction signals corresponding to duty ratios based on pulse-width modulation to the motor drivers 404. This controls rotational rates of the motors 105 of the respective motor drivers 404. The controller 401 controls the camera system 402 to control an image capturing operation of the camera 106 (see FIG. 1).

The operation until a start of the flight of the flying device 100 will now be explained.

The flying device 100 can hold the motor frames 102 in the following two modes: the “closed mode” illustrated in FIG. 1A suitable for launching the flying device 100 and the “open mode” illustrated in FIG. 1B suitable for the flight of the flying device 100. A user can launch the flying device 100 in the closed mode into air. When the flying device 100 starts to reduce its altitude under the control by the controller 401 shown in FIG. 2, the flying device 100 enters the “open mode.” When the flying device 100 reaches a flight mode at a predetermined target altitude or first distance from the reference plane (for example, two meters from ground or the reference plane), the camera 106 can capture images. In specific, the controller 401 controls the four motors 105, the four rotor blades 104, and the four motor drivers 404 such that the flying device 100 flies at a height of two meters from the ground or the reference plane (the first distance from the reference plane).

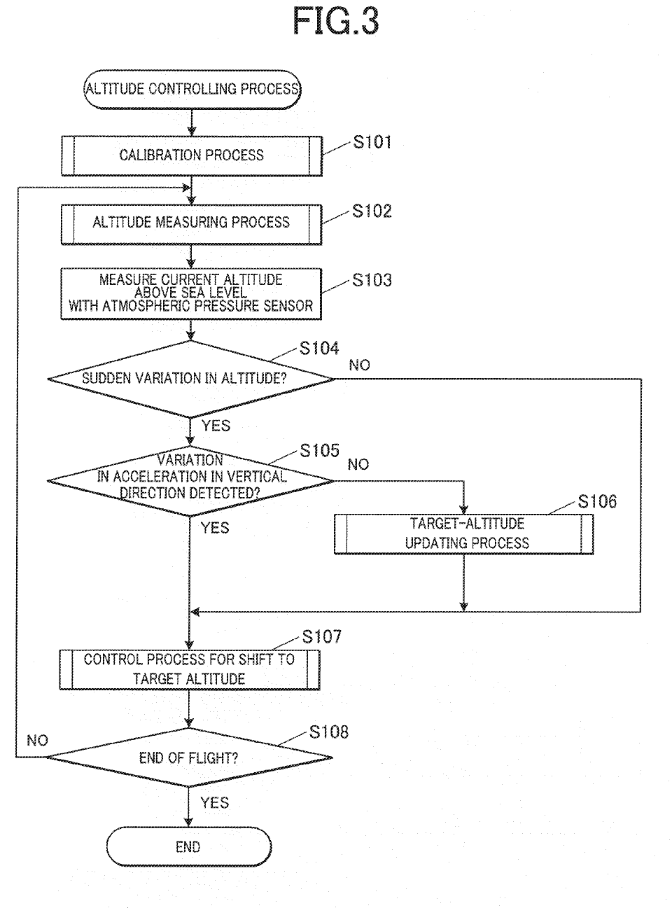

With reference to FIG. 3, an altitude controlling process carried out when the flying device 100 starts the flight will be explained. FIG. 3 is a flow chart illustrating an example of the altitude controlling process. The altitude controlling process is carried out in cooperation with a program read from a ROM (not shown) in a CPU (not shown) of the controller 401 and appropriately loaded to a RAM (not shown) of the controller 401 in response to letdown of the flying device 100 immediately after the flying device 100 is launched into the air, i.e., at the start of the flight.

With reference to FIG. 3, the controller 401 carries out a calibration process such that the flying device 100 reaches the predetermined target altitude (step S101). Details of the calibration process will be explained below.

The controller 401 carries out an altitude measuring process with the ultrasonic distance sensor 403a (step S102). Details of the altitude measuring process will be explained below.

The controller 401 measures the current altitude above sea level or the absolute altitude with the atmospheric pressure sensor 403b (step S103).

The controller 401 then checks for a sudden change in the altitude measured in step S102 (step S104). In detail, if a change rate in the altitude measured in step S102 is greater than or equal to a predetermined change rate, then the controller 401 determines occurrence of the sudden change in the altitude. If the change rate in the altitude measured in step S102 is smaller than the predetermined change rate, then the controller determines no sudden change in the altitude.

If no sudden change in altitude is determined in step S104 (NO in step S104), the controller 401 carries out step S107.

If the sudden change in altitude is determined in step S104 (YES in step S104), the controller 401 checks for detection of acceleration in a vertical direction by the acceleration sensor 403c (step S105). In detail, if a value of the acceleration in the direction of gravity output from the acceleration sensor 403c is greater than or equal to a predetermined value, then the controller 401 determines the detection of the acceleration in the vertical direction. If the value of the acceleration in the direction of gravity output from the acceleration sensor 403c is smaller than the predetermined value, then the controller determines no detection of the acceleration in the vertical direction.

If the acceleration in the vertical direction is not detected in step S105 (NO in step S105), the controller 401 determines occurrence of an environmental change and carries out an altitude updating process to update the target altitude (step S106) and then step S107. Details of the altitude updating process will be explained below.

If the acceleration in the vertical direction is detected in step S105 (YES in step S105), the controller 401 carries out a control process for shift to the target altitude (step S107). Details of the control process for the shift to the target altitude will be described below.

The controller 401 checks for an end of the flight (step S108).

If the end of the flight is determined in step S108 (YES in step S108), the controller 401 ends the altitude controlling process.

If the end of the flight is not determined in step S108 (NO instep S108), the controller 401 returns to step S102 and repeats the subsequent steps.

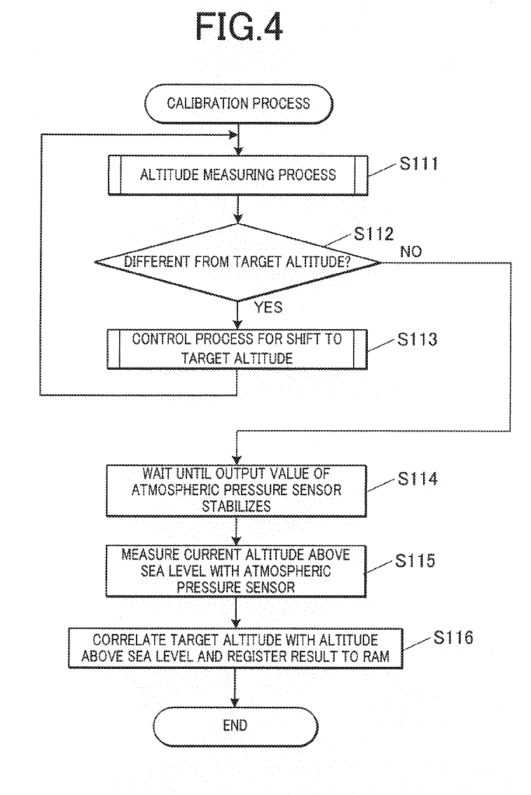

A calibration process will now be described with reference to FIG. 4. FIG. 4 is a flow chart illustrating an example of the calibration process.

The controller 401 carries out an altitude measuring process with the ultrasonic distance sensor 403a (step S111), as illustrated in FIG. 4. The controller 401 compares the altitude measured in step S111 with the predetermined target altitude (step S112).

If the measured altitude differs from the target altitude in step S112 (YES in step S112), the controller 401 carries out the control process for the shift to the target altitude (step S113) and carries out step S111.

If the measured altitude equals the target altitude, i.e., if the target altitude has been reached in step S112 (NO in step S112), the controller 401 waits until an output value of the atmospheric pressure sensor 403b stabilizes (step S114).

The controller 401 measures the current altitude above sea level or absolute altitude with the atmospheric pressure sensor 403b (step S115).

The controller 401 correlates the target altitude with the altitude above sea level measured in step S115 and registers a result to the RAM (memory) of the controller 401 (step S116). The controller 401 then ends the calibration process.

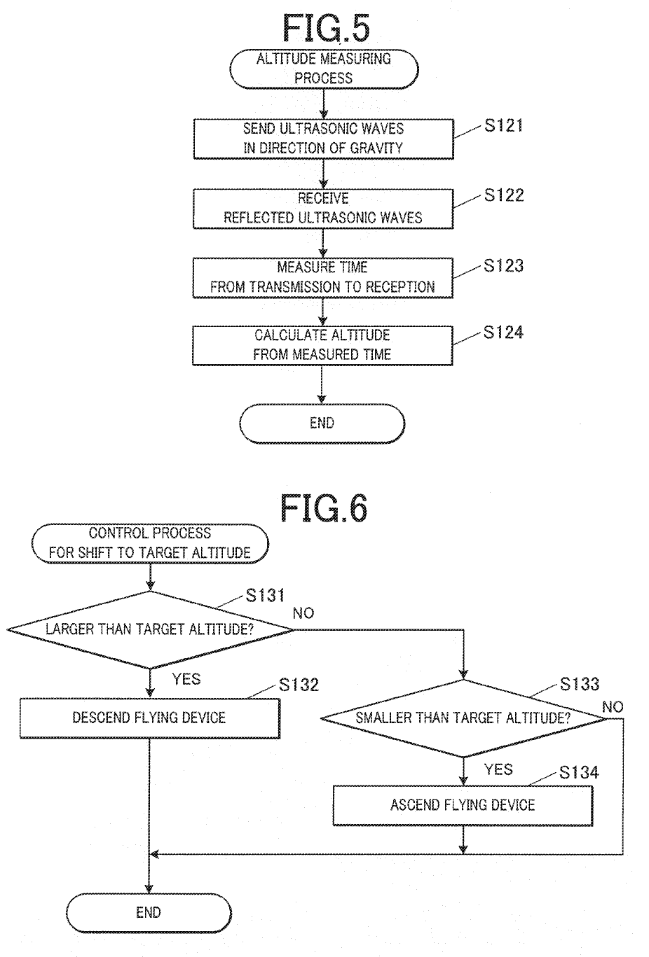

The altitude measuring process will now be explained with reference to FIG. 5. FIG. 5 is a flow chart illustrating an example of the altitude measuring process.

The controller 401 instructs the ultrasonic distance sensor 403a to emit ultrasonic waves in the direction of gravity (step S121), as illustrated in FIG. 5. The controller 401 instructs the ultrasonic distance sensor 403a to receive reflected ultrasonic waves (step S122).

The controller 401 measures a time from the emission of the ultrasonic waves to the reception of the reflected ultrasonic waves (step S123). The controller 401 calculates the altitude from the relation between the time measured in step S123 and a velocity of sound (step S124) and then ends the altitude measuring process.

The control process for the shift to the target altitude will now be described with reference to FIG. 6. FIG. 6 is a flow chart illustrating an example of the control process for the shift to the target altitude.

The controller 401 compares the current altitude with the target altitude (step S131), as illustrated in FIG. 6.

If the current altitude is larger than the target altitude in step S131 (YES in step S131), the controller 401 controls the motor drivers 404 (the propulsion unit) to descend the flying device 100 (step S132) and then ends the control process for the shift to the target altitude.

If the current altitude is not larger than the target altitude (NO in step S131), the controller 401 compares the current altitude with the target altitude (step S133).

If the current altitude is smaller than the target altitude in step S133 (YES in step S133), the controller 401 controls the motor drivers 404 (the propulsion unit) to ascend the flying device 100 (step S134) and then ends the control process for the shift to the target altitude.

If the current altitude is not smaller than the target altitude (NO in step S133), the controller 401 ends the control process for the shift to the target altitude.

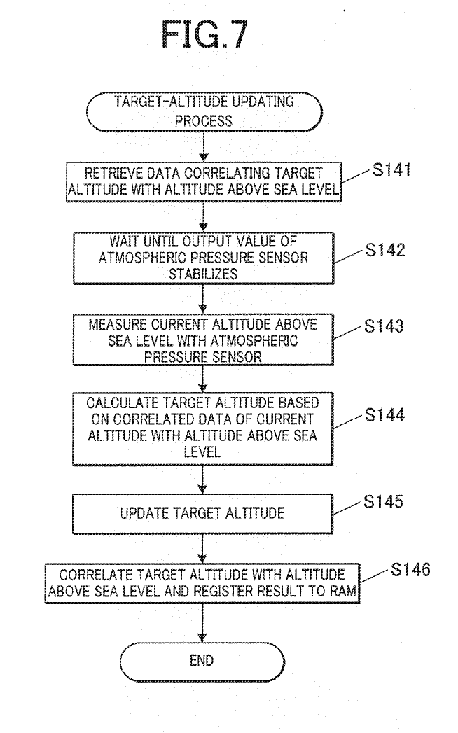

An altitude updating process will now be explained with reference to FIG. 7. FIG. 7 is a flow chart illustrating an example of the altitude updating process.

The controller 401 retrieves the correlated data of the target altitude with the altitude above sea level registered in the calibration process (see FIG. 4) from the RAM (step S141).

The controller 401 waits until the output value of the atmospheric pressure sensor 403b stabilizes (step S142).

The controller 401 measures the current altitude above sea level or absolute altitude with the atmospheric pressure sensor 403b (step S143).

The controller 401 updates the target altitude on the basis the correlated data of the current altitude with the altitude above sea level retrieved in step S141 (step S144). In specific, the controller 401 updates the target altitude by substituting individual values to a predetermined formula ([updated target altitude]=[current altitude]+[altitude above sea level of past (latest) current altitude]−[current altitude above sea level]).

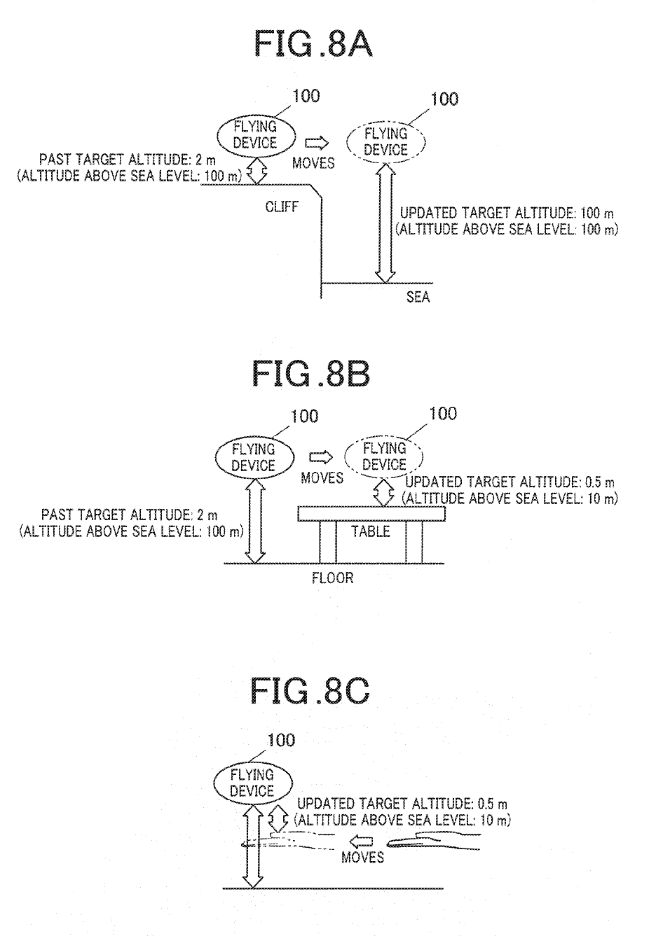

For example, with reference to FIG. 8A, the flying device 100 is flying at the target altitude of 2 m and the altitude above sea level of 100 m on a cliff and moves to fly over the sea at the current altitude of 100 m and the altitude above sea level of 100 m. The controller 401 calculates the updated target altitude (100 m) by substituting the current altitude (100 m), the altitude above sea level corresponding to the past target altitude (100 m), and the current altitude above sea level (100 m) to the predetermined formula. With reference to FIG. 8B, the flying device 100 is flying at the target altitude of 2 m and the altitude above sea level of 10 m above a floor and moves to fly over a table at the current altitude of 0.5 m and the altitude above sea level of 10 m. The controller 401 calculates the updated target altitude (0.5 m) by substituting the current altitude (0.5 m), the altitude above sea level corresponding to the past target altitude (10 m), and the current altitude above sea level (10 m) to the predetermined formula. With reference to FIG. 8C, the flying device 100 hovers at the target altitude of 2 m and the altitude above sea level of 10 m over a floor and a hand is placed immediately below the hovering flying device 100 such that the current altitude is 0.5 m and the altitude above sea level of 10 m. The controller 401 calculates the updated target altitude (0.5 m) by substituting the current altitude (0.5 m), the altitude above sea level corresponding to the past target altitude (10 m), and the current altitude above sea level (10 m) to the predetermined formula. The controller 401 updates the target altitude to the calculated value (step S145). In specific, if the occurrence of the environmental change (the shift of the reference plane) is determined, the controller 401 updates the target altitude (the first distance) to the updated target altitude (second distance) in accordance with the environmental change (the shift of the reference plane) and controls the four motors 105, the four rotor blades 104, and the four motor drivers 404 such that the flying device 100 flies at the updated target altitude.

The controller 401 correlates the updated target altitude with the altitude above sea level measured in step S143 and registers the result to the RAM (not shown) of the controller 401 (step S146). The controller 401 then ends the altitude updating process.

The atmospheric pressure sensor 403b is used in the cases illustrated in FIGS. 7, 8A, 8B, and 8C. Alternatively, the ultrasonic distance sensor 403a may be used.

As described above, the flying device 100 according to this embodiment includes the motors 105, the rotor blades 104, and the motor drivers 404, which constitute the propulsion unit for the flight; the ultrasonic distance sensor 403a determining the distance from the flying device 100 to the reference plane (the altitude); and the atmospheric pressure sensor 403b determining the absolute altitude or altitude above sea level of the flying device 100. The controller 401 determines the occurrence of the environmental change and controls the altitude of the flying device 100 on the basis of at least one of the outputs of the ultrasonic distance sensor 403a and the atmospheric pressure sensor 403b in view of the determined result.

The flying device 100 according to this embodiment can control the altitude of the flying device 100 with a sensor suitable for a variable environmental condition. Thus, the altitude of the flying device 100 can be appropriately controlled even under a sudden environmental change during the flight or hovering.

The flying device 100 according to this embodiment determines the distance between the flying device 100 and the reference plane (the altitude) with the ultrasonic distance sensor 403a and determines the absolute altitude or the altitude above sea level of the flying device 100 with the atmospheric pressure sensor 403b. Thus, the ultrasonic distance sensor 403a, which is responsive in the real time but readily affected by the environmental change, may be used in combination with the atmospheric pressure sensor 403b, which is less responsive in the real time but relatively unaffected by the environmental change to correct fluctuating values output from the ultrasonic distance sensor 403a due to the environmental change with the values output from the atmospheric pressure sensor 403b. In this way, the altitude of the flying device 100 can be appropriately controlled at substantially the real time even under the environmental change.

The flying device 100 according to this embodiment further includes the acceleration sensor 403c that determines the acceleration in the direction of gravity. The controller 401 determines the occurrence of the environmental change with the ultrasonic distance sensor 403a and the acceleration sensor 403c. This can differentiate an actual environmental change from the change in the absolute altitude of the flying device 100. Thus, erroneous determination of the occurrence of the environmental change is prevented in a case in which only the absolute altitude of the flying device 100 changes. In other words, the occurrence of the environmental change can be appropriately determined.

If the change rate in the distance (the altitude) determined by the ultrasonic distance sensor 403a is greater than or equal to the predetermined change rate and if the acceleration in the direction of gravity determined by the acceleration sensor 403c is smaller than the predetermined value, the controller 401 of the flying device 100 according to this embodiment determines no change in the absolute altitude of the flying device 100 and thus the occurrence of the environmental change, and controls the altitude of the flying device 100 on the basis of the distance determined by the ultrasonic distance sensor 403a and atmospheric pressure determined by the atmospheric pressure sensor 403b. The ultrasonic distance sensor 403a, which is responsive in the real time but readily affected by the environmental change, may be used in combination with the atmospheric pressure sensor 403b, which is less responsive in the real time but relatively unaffected by the environmental change, to correct the fluctuating values output of the ultrasonic distance sensor 403a due to the environmental change with the values output from the atmospheric pressure sensor 403b. In this way, the altitude of the flying device 100 can be appropriately controlled in substantially the real time even under the environmental change.

If the change rate in the distance (the altitude) determined by the ultrasonic distance sensor 403a is smaller than a predetermined change rate and if the acceleration in the direction of gravity determined by the acceleration sensor 403c is smaller than a predetermined value, the controller 401 of the flying device 100 according to this embodiment determines no change in the absolute altitude of the flying device 100 and no environmental change and controls the altitude of the flying device 100 on the basis of the distance determined by the ultrasonic distance sensor 403a. Thus, the altitude of the flying device 100 can be appropriately controlled in the real time.

If the change rate in the distance (the altitude) determined by the ultrasonic distance sensor 403a is greater than or equal to the predetermined change rate and if the acceleration in the direction of gravity determined by the acceleration sensor 403c is greater than or equal to the predetermined value, the controller 401 of the flying device 100 according to this embodiment determines the change in the absolute altitude of the flying device 100 and the occurrence of the environmental change, and controls the altitude of the flying device 100 on the basis of the distance determined by the ultrasonic distance sensor 403a and the atmospheric pressure determined by the atmospheric pressure sensor 403b. The ultrasonic distance sensor 403a, which is responsive in the real time but readily affected by the environmental change, may be used in combination with the atmospheric pressure sensor 403b, which is less responsive in the real time but relatively unaffected by the environmental change to correct the fluctuating values output from the ultrasonic distance sensor 403a due to the environmental change with the values output from the atmospheric pressure sensor 403b. Thus, the altitude of the flying device 100 can be appropriately controlled in the real time even under an environmental change due to the change of the absolute altitude of the flying device 100.

If the change rate in the distance (the altitude) determined by the ultrasonic distance sensor 403a is smaller than the predetermined change rate and if the acceleration in the direction of gravity determined by the acceleration sensor 403c is greater than or equal to the predetermined value, the controller 401 of the flying device 100 according to this embodiment determines the change in the absolute altitude of the flying device 100 and no environmental change, and controls the altitude of the flying device 100 on the basis of the distance determined by the ultrasonic distance sensor 403a. Thus, the altitude of the flying device 100 can be appropriately controlled in the real time.

The flying device 100 according to this embodiment further includes the RAM that correlates the target altitude of flight with the absolute altitude determined by the atmospheric pressure sensor 403b at the target altitude and stores the correlated results. If the occurrence of the environmental change is determined, the controller 401 updates the target altitude based on the absolute altitude stored in the RAM, the current distance (the altitude) determined by the ultrasonic distance sensor 403a, and the current atmospheric pressure determined by the atmospheric pressure sensor 403b. The target altitude of the flying device 100 can be updated with reference to the absolute altitude at the absolute altitude stored in the RAM even under the environmental change. Thus, the altitude of the flying device 100 can be appropriately controlled.

The controller 401 of the flying device 100 according to this embodiment controls the four motors 105, the four rotor blades 104, and the four motor drivers 404 to fly the flying device 100 at the altitude corresponding to the first distance from the reference plane, for example, 2 m from the ground. Thus, autonomous flight at a stable altitude is achieved.

If the occurrence of the environmental change (the shift of the reference plane) is determined, the controller 401 of the flying device 100 updates the past target altitude (the first distance) to the updated target altitude (the second distance) in response to the environmental change (the shift of the reference plane) and controls the four motors 105, the four rotor blades 104, and the four motor drivers 404 to fly the flying device 100 at the updated target altitude. Thus, the autonomous flight of the flying device 100 at the stable altitude is achieved even under the environmental change.

The embodiments should not be construed to limit the scope of the invention and may be modified within the scope of the invention.

For example, the controller 401 may control any number besides four of the motors 105, the rotor blades 104, and the motor drivers 404, respectively, to fly the flying device 100. In specific, the controller 401 may control at least one motor 105, at least one rotor blade 104, and at least one motor driver 404.

For example, in the embodiment described above, if the change rate in the distance (the altitude) determined by the ultrasonic distance sensor 403a is smaller than the predetermined change rate and if the acceleration in the direction of gravity determined by the acceleration sensor 403c is smaller than the predetermined value, the controller 401 determines no change in the absolute altitude of the flying device 100 and no environmental change, and controls the altitude of the flying device 100 on the basis of the distance determined by the ultrasonic distance sensor 403a. Alternatively, the altitude of the flying device 100 may be controlled on the basis of the atmospheric pressure determined by the atmospheric pressure sensor 403b.

In the embodiment described above, the flying device 100 instructs the atmospheric pressure sensor 403b to determine the absolute altitude or altitude above sea level of the flying device 100. Alternatively, the flying device 100 may include a global positioning system (GPS) sensor and determine the absolute altitude of the flying device 100 on the basis of the values output from the GPS sensor.

In the embodiment described above, the flying device 100 determines the distance between the flying device 100 and the reference plane (the altitude) with the ultrasonic distance sensor 403a. Alternatively, the flying device 100 may include a laser sensor and determine the distance between the flying device 100 and the reference plane (the altitude) on the basis of the values output from the laser range meter.

In the embodiment described above, the flying device 100 determines occurrence of the environmental change with the ultrasonic distance sensor 403a and the acceleration sensor 403c. Alternatively, occurrence of the environmental change may be determined on the basis of the image captured in the direction of gravity of the flying device 100 with the camera 106.

In the embodiment described above, if the altitude controlling process (see FIG. 3) determines the sudden change in altitude (YES in step S104) and no change in acceleration (NO in step S105), i.e., determines occurrence of the environmental change, the controller 401 carries out the altitude updating process (step S106). If conditions with or without the environmental change alternate in a predetermined cycle (for example, in a case where the flying device 100 flies in a meandering pattern along an edge of the cliff (see FIG. 8A)), the sudden change in altitude is detected, and no acceleration in the vertical direction and the sudden change in altitude are alternately detected. In such the case, the controller 401 may not carry out the altitude updating process (step S106).

In the flying device 100 according to the embodiment described above, the controller 401 including the computer or the CPU executes programs stored in the ROM (not shown) to control components such as the propulsion unit, the determiner, the controller, the control modifier, the memory, the image capturing unit, and the flight sensor. Alternatively, the flying device 100 according to the present invention may include an application specific integrated circuit (ASIC), a field-programmable gate array (FPGA), or dedicated hardware, such as various control circuits, and the dedicated hardware may control the propulsion unit, the determiner, the controller, the control modifier, the memory, the image capturing unit, and the flight sensor. In such a case, the components may be controlled by individual hardware units or controlled comprehensively by a single hardware unit. Alternatively, some of the components may be controlled by a dedicated hardware unit and the other components maybe controlled by software or firmware.

The flying device may be provided with the configuration that establishes the control according to the present invention. Alternatively, the program may be executed to instruct a conventional information processor to function as the flying device according to the present invention. In specific, the program for establishing the controls by the flying device 100 according to the embodiments described above may be executed by the CPU controlling the conventional information processor to instruct the conventional information processor to function as the flying device according to the present invention.

Such the program may be applied in any way. The program to be applied, for example, may be stored in a computer readable recording medium, such as a flexible disc, a compact disc ROM (CD-ROM), a digital versatile disc ROM (DVD-ROM), or a memory card. Alternatively, the program may be superposed onto carrier waves and used through a communication medium, such as the Internet. For example, the program may be posted on a bulletin board system (BBS) on a communication network for distribution. Alternatively, the program may be started under the control of an operating system (OS) and executed in a manner similar to other application programs, to achieve the control described above.

The embodiments described above should not be construed to limit the present invention, and the claims and other equivalents thereof are included in the scope of the invention.

What is claimed is:

1. A flying device comprising:
a propulsion unit enabling the flying device to fly in air;
a distance sensor determining a distance from the flying device to a reference plane;
a controller controlling an altitude of the flying device based on a value output from the distance sensor;
a determiner determining occurrence of an environmental change due to a shift of the reference plane; and
a control modifier modifying control of the controller in a case in which the determiner determines the occurrence of the environmental change.

2. The flying device according to claim 1, further comprising:
an altitude sensor determining an absolute altitude of the flying device, wherein,
the controller controls the altitude of the flying device based on a value output from the altitude sensor, and
the control modifier modifies the control of the controller based on the value output from the distance sensor and the value output from the altitude sensor.

3. The flying device according to claim 2, further comprising:
an acceleration sensor which detects acceleration in a direction of gravity,
wherein the determiner determines the occurrence of the environmental change with the distance sensor and the acceleration sensor.

4. The flying device according to claim 3, wherein the determiner determines the occurrence of the environmental change based on whether a change rate in the distance determined by the distance sensor is greater than or equal to a predetermined change rate and whether the acceleration in the direction of gravity determined by the acceleration sensor is smaller than a predetermined value.

5. The flying device according to claim 4, wherein the determiner determines the occurrence of the environmental change, if the change rate in the distance determined by the distance sensor is greater than or equal to the predetermined change rate and if the acceleration in the direction of gravity determined by the acceleration sensor is smaller than the predetermined value.

6. The flying device according to claim 4, wherein the determiner determines no environmental change, if the change rate in the distance determined by the distance sensor is smaller than the predetermined change rate and if the acceleration in the direction of gravity determined by the acceleration sensor is smaller than the predetermined value.

7. The flying device according to claim 2, wherein the control modifier modifies the control of the controller to a combined control based on both the value output from the distance sensor and the value output from the altitude sensor in the case in which the determiner determines the occurrence of the environmental change.

8. The flying device according to claim 2, wherein the control modifier maintains the control of the controller based on the value output from the distance sensor in a case in which the determiner determines no environmental change.

9. The flying device according to claim 2, further comprising:
a memory correlating a target altitude of the flying device during flight by the propulsion unit and the absolute altitude determined by the altitude sensor at the target altitude and storing the correlated result,
wherein the controller updates the target altitude of the flying device based on the target altitude and the absolute altitude stored in the memory, the current distance determined by the distance sensor, and the current absolute altitude determined by the altitude sensor in the case in which the determiner determines the occurrence of the environmental change.

10. The flying device according to claim 1, further comprising:
an image capturing unit capturing an image in a direction of gravity of the flying device,
wherein the determiner determines the occurrence of the environmental change based on the image captured by the image capturing unit in the direction of gravity of the flying device.

11. The flying device according to claim 1, wherein the environmental change is a change in the distance between the flying device and the reference plane due to the shift of the reference plane.

12. The flying device according to claim 1, wherein the controller controls the propulsion unit to fly the flying device at an altitude corresponding to a first distance from the reference plane.

13. The flying device according to claim 12, wherein the controller replaces the first distance with a second distance in response to the shift of the reference plane and controls the propulsion unit to fly the flying device at an altitude corresponding to the second distance from the reference plane in a case in which the determiner determines occurrence of the shift of the reference plane.

14. The flying device according to claim 2, wherein,
the distance sensor is more responsive in real time than the altitude sensor, and
the distance sensor is more readily affected by the environmental change than the altitude sensor.

15. The flying device according to claim 2, wherein,
the distance sensor comprises an ultrasonic distance sensor, and
the altitude sensor comprises an atmospheric pressure sensor.

16. The flying device according to claim 2, wherein,
the distance sensor comprises a laser sensor, and
the altitude sensor comprises a GPS sensor.

17. The flying device according to claim 1, wherein, in response to launching of the flying device by a user, the controller rotates a rotor to generate lift and change the rotor from a closed state to an open state to cause the flying device to fly, and
the controller stops rotation of the rotor to change the rotor from the open state to the closed state so that the flying device stops flight.

18. The flying device according to claim 17, wherein the flying device has a spherical shape in a case in which the propulsion unit is in the closed state.

19. A method of flying a flying device in air comprising a distance sensor, the method comprising steps of:
controlling an altitude of the flying device based on a value output from the distance sensor;
determining occurrence of an environmental change due to a shift of a reference plane; and
modifying control of a controller in a case in which the occurrence of the environmental change is determined.

20. A recording medium which stores a program executed to instruct a computer of a flying device flying in air and comprising a distance sensor, to function as:
a controller which controls an altitude of the flying device based on a value output from the distance sensor;
a determiner which determines occurrence of an environmental change due to a shift of a reference plane; and
a control modifier which modifies control of the controller in a case in which the occurrence of the environmental change is determined by the determiner.
